(19) United States
(12) Patent Application Publication
(10) Pub. No.: US 2013/0326388 A1
(43) Pub. Date: Dec. 5, 2013

(54) POWER GRID VISUALIZATION SYSTEM AND METHOD BASED ON THREE-DIMENSIONAL GIS TECHNOLOGY

(71) Applicants: STATE GRID CORPORATION OF CHINA, Beijing (CN); QINGDAO POWER SUPPLY COMPANY OF SHANDONG ELECTRIC POWER GROUP CORPORATION, Qingdao (CN)

(72) Inventors: Xiang SHI, Qingdao (CN); Sheng Chuan ZHAO, Qingdao (CN); Zhi Yong CHEN, Qingdao (CN); Xing Zhao WANG, Qingdao (CN); Ke Cun HAN, Qingdao (CN); Li Qun ZHANG, Qingdao (CN); You Jie WANG, Qingdao (CN); Cheng Ming LIU, Qingdao (CN); Qiang XU, Qingdao (CN); Xian Ming LAN, Qingdao (CN)

(21) Appl. No.: 13/906,728

(22) Filed: May 31, 2013

(30) Foreign Application Priority Data
May 31, 2012 (CN) 201210180932.X
Aug. 16, 2012 (CN) 201210292573.7

(51) Int. Cl. G06F 3/0481

(52) U.S. Cl. CPC G06F 3/04815
USPC 715/772

(57) ABSTRACT

The invention relates to a power grid visualization system and a power grid visualization method based on a three-dimensional geographic information system (GIS) technology. Models to be loaded are divided into different model loading subtasks according to the difference of object types included in a scene to be loaded, and model files are called in parallel from a plurality of subtasks in a multi-thread mode; and meanwhile, on the basis that loading tasks are divided into a plurality of model loading subtasks according to the loaded object types, model files of objects of each type are only read once, moreover, reuse of the model files is not limited to a client loading task, different clients can reuse the read model files, and the characteristics of limited type and relatively consistent specification of power equipment are fully considered, so that rereading of the model files of the same type is avoided.

### FIELD OF THE INVENTION

The invention relates to a three-dimensional geographic information system, and in particular to a power grid visualization system and a power grid visualization method based on a three-dimensional geographic information technology.

### BACKGROUND OF THE INVENTION

GIS (Geographic Information System) is a technical system for scientifically managing and comprehensively analyzing geographic data with space meaning based on a geographic spatial database under the support of computer software and hardware by using the theories of system engineering and information science so as to provide information required by management, decision and the like. Briefly, the GIS is a technical system for comprehensively processing and analyzing geographic spatial data, and relates to a global spatial analysis real-time technology using mapping and surveying as basis, using a database as a data source for data storage and use and using computer programming as a platform.

With the improvement of voltage level and the enlargement of scale of power grids, the gradual execution of commercial operation the power grids provides new requirements on construction and maintenance of city power distribution. In the city power distribution industry, a two-dimensional GIS technology has already been deeply and widely applied in production, operation and management, and good effects are achieved. But in practical work, the defects of the two-dimensional GIS technology on information representation are gradually exposed. For example, the two-dimensional GIS represents actual ground objects of different types by using characters of points, lines, planes and the like in different layers, and has the biggest defects that geometric figures are simple and the topography around power facilities such as circuits and pole towers cannot be really reflected. The two-dimensional GIS cannot represent the details of primary and secondary equipment and topological connection thereof in a transformer station, and also cannot represent the geographical environment along a transmission and distribution line and the spatial position relation between the geographical environment and transmission and distribution line equipment. Although the conventional primary wiring diagram or secondary wiring diagram can express the connection relation of the internal equipment of the transformer station, the wiring diagram is only a schematic diagram of topological connection and cannot reflect the spatial relative relation of the equipment. When a power grid is required to be rebuilt or expanded, the two-dimensional GIS cannot reflect the spatial position relation between power equipment and the surrounding objects, and rebuilding or expanding constructors are required to carry out measurement on a power grid site to acquire the spatial position data, so time and labor are wasted, and smooth rebuilding or expanding work is not favored. However, the three-dimensional GIS can meet the demand.

Disclosed in the Chinese patent document CN102323996A is a visual state system based on a three-dimensional GIS technology. The system consists of a geographic information data display module, an equipment model data display module and a state data display module, wherein the geographic information data display module adopts a data storage technology based on a pyramid structure and a dynamic levels of detail (LOD) technology; the equipment model data display module realizes quick browsing of high-precision online equipment models by adopting a mode combining progressive transmission and vertex type; the equipment data display module realizes state data display by adopting a particle system; the system realizes three-dimensional topography simulation of a transmission line corridor and three-dimensional display of a transmission equipment state based on the three-dimensional GIS technology through multi-angle and all-directional display of massive spatial information, so that an information support is provided for improving the fine, scientific and intelligent level of power equipment operation management. According to the patent document, power grid data are acquired in real time and modeling is completed in real time, so that each object included in the scene is required to be modeled and loaded, the modeling and loading workload is large, and the display speed is relatively low.

Generally, geographic transactions and landscape object information involved in the three-dimensional GIS are complex, and the data are quite huge; as a power grid information system, the three-dimensional GIS displays a limited variety of power equipment such as a transformer station, an overhead line, a cable line and a power distribution room; the power equipment is linearly arranged along a transmission and distribution line on a macro level, and various browses are forward or backward browses based on the current browsing scene along the transmission and distribution line; and the patent document ensures quick browsing according to the data storage mode and the transmission form used in the modeling process, but the characteristics of limited types and relatively consistent specification of the power equipment are not fully considered or utilized, and each object is required to be modeled and loaded, so the modeling and loading workload is large, and the browsing speed has yet to be further improved.

### SUMMARY OF THE INVENTION

In order to solve the technical problem of relatively low loading speed due to real-time modeling and loading of each object by the visual state system based on the three-dimensional GIS technology in the prior art, the invention provides a power grid visualization system and a power grid visualization method based on a three-dimensional geographic information technology for realizing real-time visualization by fully using the characteristic of single types of power equipment.

In order to solve the technical problem, the invention adopts the following technical solution:

A power grid visualization method based on a three-dimensional geographic information technology, comprising the following steps:

S01, receiving scene information to be displayed by a client, forming a scene loading instruction and transmitting the scene loading instruction to a server;

S02, receiving the scene loading instruction by the server, performing decomposition on objects included in a scene according to types to acquire different three-dimensional model loading subtasks, acquiring the storage positions of three-dimensional model files by accessing a three-dimensional model file addressing information table, reading the three-dimensional model file of each model in parallel, and completing reading and output of the model file of the first object of each type;

S03, receiving the model files read in step S02 by the server, wherein the models of other different objects of the same type directly use the read model file of the first object; and

S04, extracting the model file of each object by the server, combining the model files to GIS information to generate a three-dimensional scene diagram and outputting the three-dimensional scene diagram to the client.

After step S04, the method also comprises a model preloading step, specifically, when the client displays the current scene, the server determines previous scene information and later scene information of the current scene requested by the client according to the connection relation between loaded power grid equipment and corresponding power grid equipment and preloads and outputs the model files required by a previous scene and a later scene of the current scene.

Step S02 also comprises a step of selecting model files of objects with corresponding granularity according to the ratios of the objects to the whole scene.

After step S04, the method also comprises the following steps:

S05, judging whether an instruction for further displaying object affiliated information is received or not by the client, and outputting the instruction and turning to S06 if said instruction is received; and

S06, receiving the instruction request of step S05 by the server, reading an index file of the objects, finding the storage positions of the affiliated information of the objects according to the indexes of the objects, then reading the affiliated information of the objects from a database according to the storage positions, and outputting the affiliated information.

Each index comprises the name and the ID of the corresponding object.

A power grid visualization system based on the three-dimensional GIS technology, comprising:

a database for storing three-dimensional geographic information, power grid equipment data and an addressing information table of various three-dimensional model files, wherein the three-dimensional model file addressing information table stores the storage position information of various three-dimensional model files;

a client for receiving scene information to be displayed, transmitting the scene information to a server and receiving and displaying scene data output by the server; and

the server for calling the model files according to the scene information and outputting the model files;

the server further comprises:

a calculation and decomposition module for dividing models to be loaded into different model loading subtasks according to the difference of types of objects included in a scene, calling the model files in parallel from a plurality of model loading subtasks in a multi-thread mode and outputting the model files, wherein calling of the model files means to acquire the storage positions of the three-dimensional model files from the three-dimensional model file addressing information table in the database and then read the model files;

a loading result reusing module for receiving the model files called by the calculation and decomposition module, wherein the other different objects of the same type directly use the read model files; and

a loading combination module for combining the model file of each object to GIS information to generate a three-dimensional scene diagram and outputting the three-dimensional scene diagram.

The server also comprises a scene preloading module for determining previous scene information and later scene information of the current scene requested by the client according to the connection relation between loaded power grid equipment and corresponding power grid equipment and preloading and outputting the model files required by a previous scene and a later scene of the current scene.

The three-dimensional model files of one object comprise a plurality of three-dimensional model files with different granularities.

An index file is also stored in the server, and a mapping relation between the objects and the storage positions of affiliated information consisting of three-dimensional geographic information data or power grid equipment data corresponding to the objects is stored in the index file.

Each index in the index file comprises the name and the ID of the corresponding object.

The technical solution of the invention has the following advantages:

The invention relates to the power grid visualization system and the power grid visualization method based on the three-dimensional GIS technology, wherein models to be loaded are divided into different model loading subtasks according to the difference of object types included in the scene to be loaded, and model files are called in parallel from a plurality of subtasks in a multi-thread mode, so that the loading speed is improved; and on the basis that loading tasks are divided into a plurality of model loading subtasks according to the loaded object types, model files of objects of each type are only read once, the model files of the objects of the same type are not required to be reloaded, only the first read model files are required, moreover, reuse of the model files is not limited to a client loading task, different clients can reuse the read model files, and the characteristics of limited type and relatively consistent specification of power equipment are fully considered, so that rereading of the model files of the same type is avoided, the reading frequency of the model files in a disk is reduced, the loading workload is effectively reduced, the loading efficiency can be remarkably improved, quick loading is ensured, and real-time browsing of the clients is ensured.

By setting the three-dimensional model file addressing information table, all information of models can be acquired from the model files at one time, and multi-times disk reading operation in the conventional model loading is not required, so that the disk reading speed is improved.

By setting the scene preloading module, when the current scene is displayed, the model files of the objects in the previous scene and the later scene of the current scene can be preloaded by a background server; and when the display request of the next scene arrives, the next scene can be displayed immediately, so that the instantaneity of display can be greatly improved.

By establishing the indexes, when the model loading is completed and affiliated data are required to be displayed, only the storage positions of the affiliated data corresponding to each object are required to be found through the indexes, and then the data stored in the database are read, so that the reading frequency of the disk is reduced, the disk reading speed is improved, quick processing of the loaded tasks is ensured, and the loading speed is improved.

### DRAWINGS OF THE INVENTION

In order that the contents of the invention are more easily understood, the disclosure of the invention is further illustrated in conjunction with the drawings and the embodiments:

FIG. 1 is a structural schematic diagram of a power grid visualization system based on a three-dimensional GIS technology in an embodiment of the invention; and

FIG. 2 is a working flow diagram of the system as shown in FIG. 1.

### DETAILED DESCRIPTION OF THE EMBODIMENTS

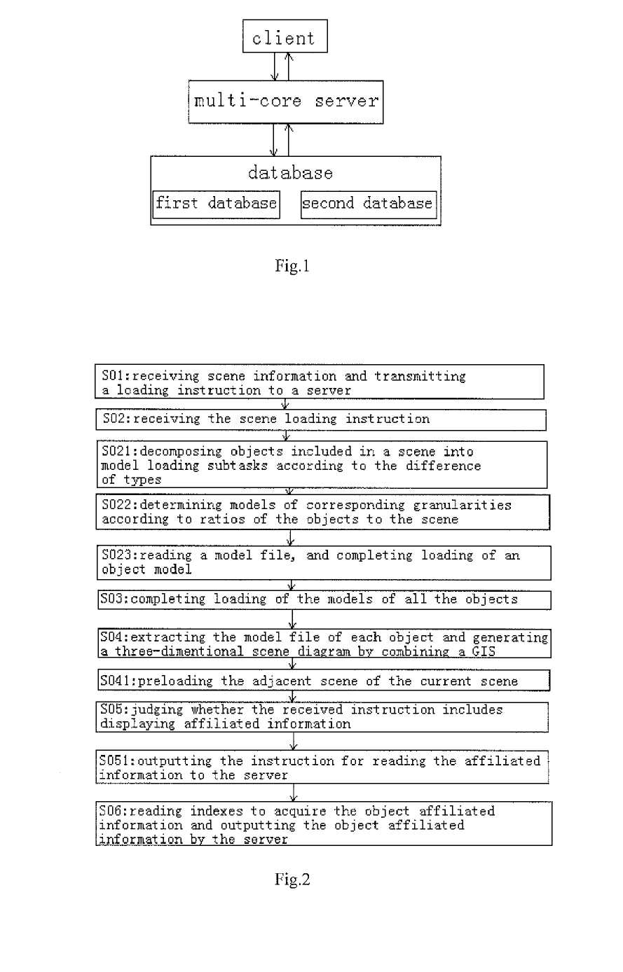

Please see the FIG. 1, a power grid visualization system based on a three-dimensional GIS technology in an embodiment of the invention, comprises:

a database, which further comprises a first database for storing three-dimensional geographic information, a second database for storing power grid equipment data and a three-dimensional model file addressing information table (not shown in the figure), wherein names of models and address information of three-dimensional model files of the models are stored in the three-dimensional model file addressing information table, various three-dimensional model files are directly stored in a hard disk of a server, and each three-dimensional model comprises three-dimensional models of an object of any type in a scene, such as three-dimensional models of buildings, streets, transformer stations, wire poles and the like; when reading the model files, the server should read the storage position of a required model file from the three-dimensional model file addressing information table in the database, and then read the model file from the disk at one time and send it to a client, and loading of a model is completed; an index file (not shown in the diagram) is stored in the hard disk of the server; the index file stores a mapping relation between an object and the storage position of the affiliated information of the object consisting of geographic information data (for example, information such as the construction organization and the construction time of a building) or power grid equipment data (for example, maintenance records of a wire pole, electric parameters of a wire bound on the wire pole, etc.) corresponding to the object; when the data of a certain object are required to be further displayed in the display process after model loading, for example, a mouse clicks the certain object to give out an instruction for further displaying the affiliated information, the client transmits the instruction for displaying the affiliated information to the server, and the server is only required to find the storage position of the three-dimensional geographic information data or the power grid equipment data corresponding to the object through an index and read the corresponding affiliated information data from the database, so that the disk reading frequency is reduced, the disk reading speed is improved, quick processing of loaded tasks is ensured, and the loading speed is improved; Through preliminarily loading scene information consisting of models and only re-loading the affiliated information subsequently, the requirement of the client for quick browsing can met, in addition, the demand of browsing of the client can also be met by subsequently loading the specific affiliated information of the objects interested by the client through secondary operation; as one embodiment of the invention, the power grid equipment data are updated in real time according to the power data of a power grid site, for example, the second database is connected with a power data acquisition device of the power grid site to acquire and update the power equipment data in real time; and in view of great difference between the three-dimensional geographic information and the power grid equipment data structure, the data are stored respectively, so that uniformity of data formats can be ensured, and multiplexing of the conventional database can be facilitated;

a client, on the one hand, used for receiving the scene information to be displayed, transmitting the scene information to the server, sending a request for displaying a required scene to the server and starting a loading operation; on the other hand, after loading, receiving and displaying scene data output after loading of the server, wherein in this embodiment, one client is adopted;

a server, wherein in one embodiment of the invention, the server is a multi-core server and can be used for parallel processing, so that the parallel processing capability of the server is improved; the server receives the request sent by the client and carries out loading and output according to the scene information to be loaded; the server specifically comprises:

a calculation and decomposition module, used for dividing models to be loaded into different model loading subtasks according to the difference of types of objects included in a scene, wherein each model loading subtask is used for reading a model file; running a plurality of subtasks in parallel on a plurality of cores included in the server in a multi-thread mode, namely reading the model files in parallel, wherein reading of the model files means to acquire the storage positions of the three-dimensional model files from the three-dimensional model file addressing information table in the database and then read the model fields; before loading, selecting the model files of the corresponding granularities of the objects according to the ratios of the objects to the scene; through hierarchical management of the three-dimensional models of the objects, the scene comprises a plurality of objects during far-end observation, namely rough models with high granularities are adopted, and fine models with low granularities are adopted in the objects during near-end observation, so that the visual effect from far to close and from fussy to clear can be achieved, and the efficiency of the system can be greatly improved;

a loading result reusing module, used for receiving the model files read by the calculation and decomposition module, wherein the other different objects of the same type directly use the read model files; certainly, the loading result reusing is suitable not only for the same client, but also for different requests sent by different clients, before executing the model loading subtasks, the server judges whether a corresponding model file is stored in a cache or not, if it is stored, the model file is directly loaded to the clients, and response of the request is completed; and when there exists a reusing basis during model loading of different clients, the server reuses the loaded model files likewise, so that the workload for rereading the model files can be greatly reduced, the disk reading frequency is reduced, and further the loading efficiency is improved;

a loading combination module, used for combining the model file of each object to respective GIS information to generate a three-dimensional scene diagram and outputting the three-dimensional scene diagram; and

a scene preloading module, wherein the server determines previous scene information and later scene information of the current scene requested by the client according to a connection relation between loaded power grid equipment and corresponding power grid equipment, the server actively preloads the model files of the objects in the previous scene information and the later scene information of the scene and stores the read model files in the cache, and the read model files are temporarily not output; when the corresponding scene display request arrives, the server can immediately respond to the request, combine the model files to respective GIS information to generate a three-dimensional scene diagram and output the three-dimensional scene diagram to the client in first time for displaying.

In the embodiment, the index in the file comprises name and ID of the corresponding object, so that single index is avoided, and the object can be conveniently and quickly searched.

In the embodiment, a method for the power grid visualization system based on the three-dimensional GIS technology, (see what is shown in FIG. 2), comprising the following steps:

S01, receiving scene information to be displayed by a client, forming a scene loading instruction and transmitting the scene loading instruction to a server;

S02, receiving the scene loading instruction by the server as the following steps:

S021, decomposing objects included in a scene according to types to acquire model loading subtasks of different types;

S022, selecting models of objects with corresponding granularity according to the ratios of the objects to the whole scene, acquiring different specific model loading subtasks, acquiring the storage positions of the three-dimensional model files by accessing a three-dimensional model file addressing information table, reading the three-dimensional model file of each model in parallel, and completing reading and output of the model file of the first object of each type;

S023, reading the storage positions of the model files in parallel, reading the model files, and completing loading and output of the model of the first object of each type;

S03, receiving the model files read in step S02 by the server, wherein the models of other different objects of the same type directly use the read model file of the first object till loading of all the objects is completed; and

S04, extracting the model file of each object by the server, combining the model files to GIS information to generate a three-dimensional scene diagram and outputting the three-dimensional scene diagram to the client for displaying;

S041, determining previous scene information and later scene information of the current scene requested by the client according to the connection relation between loaded power grid equipment and corresponding power grid equipment and preloading the model files included in a previous scene and a later scene of the current scene by the server, temporarily storing the loading result, and outputting the loading result by the server in first time for displaying when the display request is received, wherein when the current scene is at the head end or the tail end of the power distribution system, only the previous scene or the later scene is loaded till current browsing is ended;

S05, judging whether an instruction for further displaying object affiliated information is received or not;

S051, if the instruction is received, outputting the instruction to the server; and

S06, receiving the instruction of step SOS, reading the index of the object, then reading affiliated information from the database and outputting the affiliated information to the client for displaying by the server.

In the embodiment, the indexes are multi-keyword indexes comprising names and unique IDs, and searching can be completed through any keyword, so that searching is more convenient.

At the moment, a typical browsing process is completed. If the client wants to browse the previous or later adjacent scene of the current scene at the moment, a request is directly sent to the server, and the server directly outputs the preloading result temporarily stored in the cache, thus quick browsing is completed; and if the client closes the current browsed page, the whole browsing process is ended.

The invention relates to the power grid visualization system and the power grid visualization method based on the three-dimensional GIS technology, wherein models to be loaded are divided into different model loading subtasks according to the difference of object types included in the scene to be loaded, and model files are called in parallel from a plurality of subtasks in a multi-thread mode, so that the loading speed is improved; and on the basis that loading tasks are divided into different model loading subtasks according to the loaded object types, model files of objects of each type are only required to be read once, the model files of the objects of the same type are not required to be reloaded, only the first read model files are required, moreover, reuse of the model files is not limited to a client loading task, different clients can reuse the read model files, and the characteristics of limited type and relatively consistent specification of power equipment are fully considered, so that rereading of the model files of the same type is avoided, the reading frequency of the model files in a disk is reduced, the loading workload is effectively reduced, the loading efficiency can be remarkably improved, quick loading is ensured, and real-time browsing of the clients is ensured. When the power grid is expanded or the old grid is rebuilt, the system can display the three-dimensional position relation of the power grid in real time, so that aided designing is facilitated, and time and labor are saved.

In other embodiments of the invention, each index can be a single index for one of the name and the ID of each object, the objects of the invention can be fulfilled likewise, and the other embodiments belong to the protection scope of the invention.

In the other embodiments of the invention, the multi-core server can be replaced by the server cluster in the prior art, parallel processing is executed through a plurality of central processing units (CPU) of a plurality of servers, the objects of the invention can be fulfilled likewise, and the other embodiments belong to the protection scope of the invention.

Obviously, the embodiments are only examples used for clear illustration rather than limiting modes of implementation. For those ordinary skilled in the art, variation or modification in other different forms can be made on the basis of the illustration. All embodiments are not required to or cannot be listed here, and obvious variation or modification derived from the embodiments is still within the protection scope of the claims of the invention.

1. A power grid visualization method based on a three-dimensional geographic information system (GIS) technology, comprising the following steps:
S01, receiving scene information to be displayed by a client, forming a scene loading instruction and transmitting said scene loading instruction to a server;
S02, receiving said scene loading instruction by said server, decomposing objects included in a scene according to types to acquire different three-dimensional model loading subtasks, acquiring storage positions of three-dimensional model files by accessing a three-dimensional model file addressing information table, reading the three-dimensional model file of each model in parallel, and completing reading and output of said model file of a first object of each type;
S03, receiving said model files read in step S02 by said server, wherein the models of other different objects of the same type directly use the read said model file of said first object; and
S04, extracting said model file of each object by said server, combining said model files to GIS information to generate a three-dimensional scene diagram and outputting the three-dimensional scene diagram to the client.

2. The power grid visualization method based on the three-dimensional GIS technology of claim 1, wherein, after step S04, the method further comprises a model preloading step that when said client displays the current scene, said server determines previous scene information and later scene information of the current scene requested by said client according to the connection relation between loaded power grid equipment and corresponding power grid equipment and preloads and outputs said model files required by a previous scene and a later scene of the current scene.

3. The power grid visualization method based on the three-dimensional GIS technology of claim 1, wherein, step S02 further comprises a step of selecting said model files of objects with corresponding granularity according to the ratios of the objects to the whole scene.

4. The power grid visualization method based on the three-dimensional GIS technology of claim 3, wherein, after step S04, the method further comprises the following steps:
S05, judging whether an instruction for further displaying object affiliated information is received or not by the client, and outputting the instruction and turning to S06 if said instruction is received; and
S06, receiving said instruction in step S05 by said server, reading an index file of the objects, finding storage positions of said affiliated information of the objects according to the indexes of the objects, then reading said affiliated information of the objects from a database according to said storage positions, and outputting said affiliated information.

5. The power grid visualization method based on the three-dimensional GIS technology of claim 4, wherein, each index comprises name and ID of each object.

6. A power grid visualization system based on the three-dimensional GIS technology for implementing the method of claim 1, comprising:
a database, for storing three-dimensional geographic information, power grid equipment data and an addressing information table of various three-dimensional model files, wherein three-dimensional model file addressing information table stores the storage position information of various three-dimensional model files;
a client, for receiving scene information to be displayed, transmitting said scene information to a server and receiving and displaying scene data output by said server; and
a server, for calling said model files according to said scene information and outputting said model files;
wherein, said server further comprises:
a calculation and decomposition module, for dividing models to be loaded into different model loading subtasks according to the difference of types of objects included in a scene, calling said model files in parallel from a plurality of model loading subtasks in a multi-thread mode and outputting said model files, and calling of said model files is implemented by acquiring storage position information of said three-dimensional model files from said three-dimensional model file addressing information table in said database and then read said model files;
a loading result reusing module, for receiving said model files called by said calculation and decomposition module, wherein the other different objects of the same type directly use the read model files; and
a loading combination module, for combining said model file of each object to GIS information to generate a three-dimensional scene diagram and outputting said three-dimensional scene diagram.

7. The power grid visualization system based on the three-dimensional GIS technology of claim 6, wherein, said server also comprises a scene preloading module for determining previous scene information and later scene information of the current scene requested by said client according to a connection relation between loaded power grid equipment and corresponding power grid equipment and preloading and outputting said model files required by a previous scene and a later scene of the current scene.

8. The power grid visualization system based on the three-dimensional GIS technology of claim 6, wherein, said three-dimensional model files of one object comprise a plurality of three-dimensional model files with different granularities.

9. The power grid visualization system based on the three-dimensional GIS technology of claim 8, wherein, an index file is also stored in said server, and a mapping relation between said objects and storage positions of affiliated information consisting of three-dimensional geographic information data or power grid equipment data corresponding to said objects is stored in the index file.

10. The power grid visualization system based on the three-dimensional GIS technology of claim 9, wherein, each index in the index file comprises name and ID of the corresponding object.

11. The power grid visualization method based on the three-dimensional GIS technology of claim 2, wherein, step S02 further comprises a step of selecting said model files of objects with corresponding granularity according to the ratios of the objects to the whole scene.

12. The power grid visualization method based on the three-dimensional GIS technology of claim 11, wherein, after step S04, the method further comprises the following steps:
S05, judging whether an instruction for further displaying object affiliated information is received or not by the client, and outputting the instruction and turning to S06 if said instruction is received; and
S06, receiving said instruction in step S05 by said server, reading an index file of the objects, finding storage positions of said affiliated information of the objects according to the indexes of the objects, then reading said affiliated information of the objects from a database according to said storage positions, and outputting said affiliated information.

13. The power grid visualization method based on the three-dimensional GIS technology of claim 12, wherein, each index comprises name and ID of each object.

14. The power grid visualization system based on the three-dimensional GIS technology of claim 7, wherein, said three-dimensional model files of one object comprise a plurality of three-dimensional model files with different granularities.

15. The power grid visualization system based on the three-dimensional GIS technology of claim 14, wherein, an index file is also stored in said server, and a mapping relation between said objects and storage positions of affiliated information consisting of three-dimensional geographic information data or power grid equipment data corresponding to said objects is stored in the index file.

16. The power grid visualization system based on the three-dimensional GIS technology of claim 15, wherein, each index in the index file comprises name and ID of the corresponding object.
